(19) United States
(12) Patent Application Publication
(10) Pub. No.: US 2022/0217961 A1
(43) Pub. Date: Jul. 14, 2022

(54) MULTI-LAYERED INVERTED HORSESHOE AND METHODS OF USING SAME

(71) Applicant: Challen Ingraham, Tabernacle, NJ (US)

(72) Inventor: Challen Ingraham, Tabernacle, NJ (US)

(21) Appl. No.: 17/148,574

(22) Filed: Jan. 14, 2021

(51) Int. Cl. A01L 5/00; A01L 3/00

(52) U.S. Cl. CPC A01L 5/00; A01L 3/00

(57) ABSTRACT

A horseshoe having a front end and a back end includes a main body, a pair of side branches coupled to opposing ends of the main body, a heel wedge coupled to the main body, and a cushioning base coupled to the main body, the cushioning base including at least two layers of different stiffnesses.

### FIELD OF THE DISCLOSURE

The present disclosure relates to devices and methods for treating certain diseases in hoofed animals. More particularly the present disclosure relates to specialty horseshoes for hoofed animals having conditions, such as laminitis.

### BACKGROUND OF THE DISCLOSURE

Proper load distribution on a horse's feet is important to the overall health of the animal. Laminitis is a serious medical condition in horses and other hoofed animals, and despite significant advances in veterinarian medicine, remains a major reason for euthanasia of such animals. Laminitis is an inflammation of the lamina and the inner hoof wall. Laminitis is characterized by separation of the hoof wall from the distal phalanx due to the deterioration and detachment of the lamina, which holds the two together. Failure of the laminar attachments, in a majority of cases is limited to the toe region. It is hypothesized that without the distal phalanx properly attached to the inside of the hoof wall, the weight of the horse and the forces of locomotion by the deep digital flexor tendon cause the distal phalanx to rotate away from the hoof capsule. This process shears the vasculature and crushes the corium (dermis) of the sole, causing unrelenting pain and a characteristic lameness. Radiographic and necropsy examination of the feet of affected horses show a characteristic rotation of the dorsal border of the distal phalanx away from the dorsum of the hoof wall.

Laminitis can occur secondary to many diseases of the horse, but is common following overeating, colic, fever, shock, pneumonia, injury and obesity.

Many hoofed animals, and particularly horses, are susceptible to laminitis and significant economic loss occurs due to severe pain and debilitation of these animals. Due to the insidious nature of the disease process, damage to the laminae often occurs prior to clinical evidence of abnormality.

Current medical therapies include identification and treatment of the underlying disease, systemic anti-inflammatory medications and rest. A more aggressive treatment of the sequela of laminitis involves severing the deep digital flexor tendon. Additionally, support of the sole has met with some success utilizing deep sand flooring, peat moss and foam sole pads.

Surgical transection of the deep digital flexor tendon (DDFT) has also been used to reduce the shearing forces during the acute phase of laminitis. One study reported a 60% survival rate at 2 years after the procedure. Those animals who do recover from the severing of the deep digital flexor tendon are usually not comfortable enough to ride. Even with these issues in mind, current veterinary practices suggest that a deep digital flexor tenotomy is the fastest way to counteract the rotational forces and restore the perfusion and tissue mass to the dorsal regions of the foot.

Other conventional methods include the use of wedge shoes, but these suffer from several shortcomings.

### SUMMARY OF THE DISCLOSURE

In some embodiments, a horseshoe having a front end and a back end includes a main body, a pair of side branches coupled to opposing ends of the main body, a heel wedge coupled to the main body, and a multi-layer cushioning base coupled to the main body, the multi-layer cushioning base including at least two layers of different stiffnesses.

### BRIEF DESCRIPTION OF THE DISCLOSURE

Various embodiments of the presently disclosed horseshoes are shown herein with reference to the drawings, wherein:

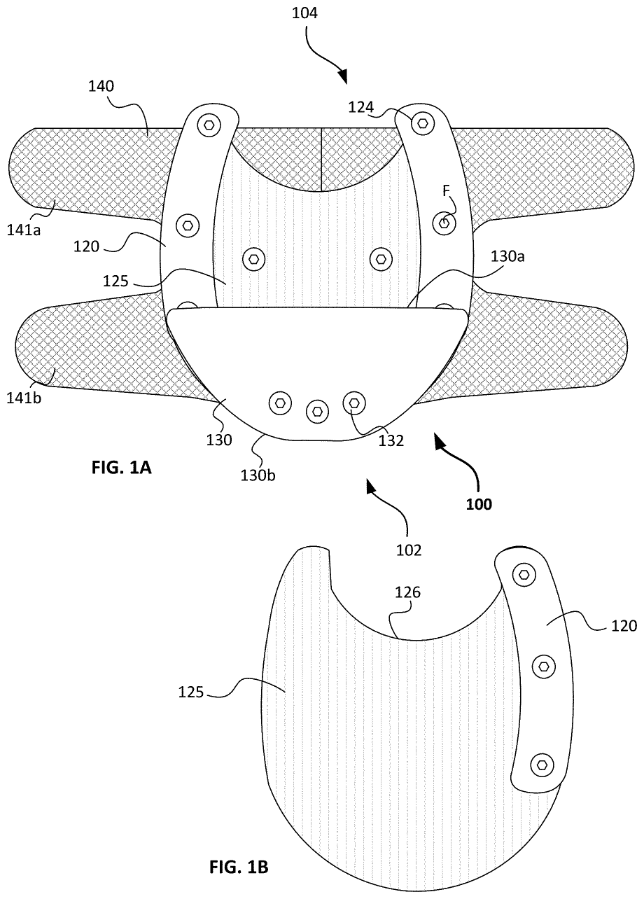

FIG. 1A is a schematic bottom view of one example of a horseshoe according to the present disclosure;

FIG. 1B is a schematic bottom view of a main body and a side branch according to the present disclosure;

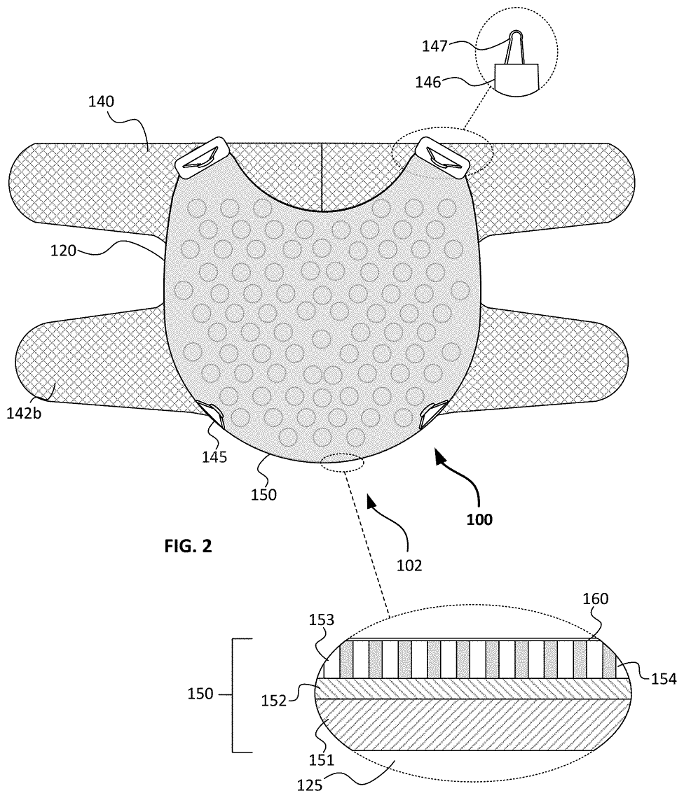

FIG. 2 is a schematic top view of the horseshoe of FIG. 1;

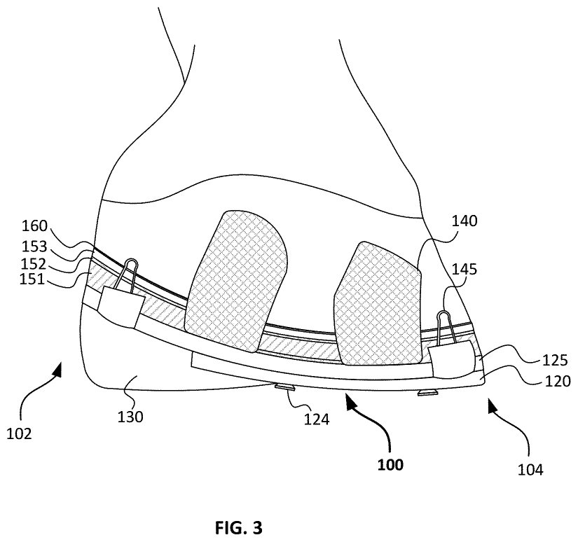

FIG. 3 is a schematic side view of the horseshoe of FIG. 1 during use; and

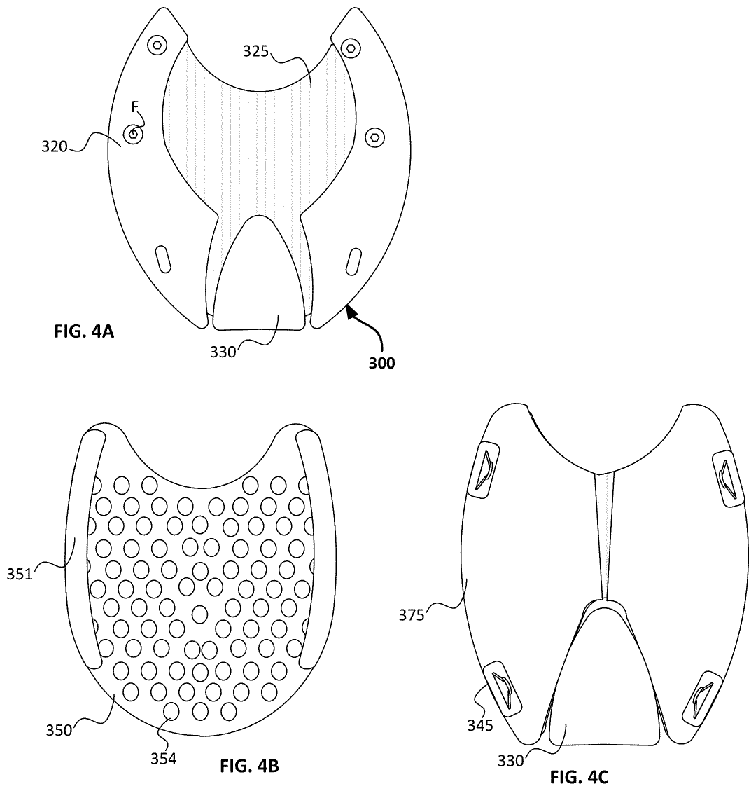

FIGS. 4A-C are schematic top and bottom view of various layers of another embodiment of a horseshoe.

Various embodiments of the present invention will now be described with reference to the appended drawings. It is to be appreciated that these drawings depict only some embodiments of the invention and are therefore not to be considered limiting of its scope.

### DETAILED DESCRIPTION

Despite the various improvements that have been made to horseshoes and their methods of use, conventional devices suffer from some shortcomings as described above.

There therefore is a need for further improvements to the devices, systems, and methods of providing support to hoofed animals. Among other advantages, the present disclosure may address one or more of these needs. As used herein, the term “front” will refer to a location or direction closer to an animal's toe and the term “back” will refer to a location or direction closer to the animal's heel. “Top” refers to a structure closer to the hoof of an animal, while “bottom” refers to a structure further farther from the animal's hoof.

FIG. 1 illustrates a generally U-shaped horseshoe 100, the horseshoe having an inverted orientation that is the opposite of a traditional horseshoe so as to include a connected or closed portion adjacent the back end 102 (i.e., adjacent the horse's heel), and an open portion adjacent the front end 104 (i.e., adjacent the horse's toe). Traditional horseshoes are closed near the toe and open near the heel.

Horseshoe 100 includes several components coupled together, which will be appreciated from examining the bottom view of the horseshoe of FIG. 1A, and the corresponding top and side views of FIGS. 2-3. Beginning with the lowermost element, as shown in FIG. 1, horseshoe 100 includes a semicircular or crescent-shaped heel wedge 130. Heel wedge 130 may be formed of a hard plastic or metal. In one example, heel wedge 130 may have a shape that includes a lower curved portion 130a and a straight edge 130b. Lower curved portion 130a may mimic the curvature of a traditional horseshoe and includes a number of first holes 132 aligned with the straight edge to couple the wedge to other components via fasteners or screws “F”. Heel wedge 130 may also have varying heights that provide an inclined or sloped surface to support the heel of the animal such that the heel wedge is thickest adjacent back end 102 (i.e., adjacent the lower curved portion) and thinnest adjacent the straight edge.

Heel wedge 130 may be coupled to side branches 120 and/or main body 125. As shown in FIG. 1B, main body 125 may be substantially oval or egg-shaped with a concavity or cutout 126 adjacent front end 104. A single side branch 120 is shown in FIG. 1B for the sake of illustration, but it will be understood that two side branches 120 are coupled, one to either side of the main body 125. In some examples, main body 125 is made of acrylonitrile butadiene styrene (ABS) or other similar polymer, or any other suitable material. In the example shown, main body 125 may be coupled directly to heel wedge 130. Alternatively, heel wedge may be coupled to main body 125 indirectly via side branches 120.

A pair of side branches 120 are removably coupleable to heel wedge 130 and/or main body 125, and may be sandwiched therebetween. In some examples, side branches 120 are made of the same material as main body 125. Alternatively, branches 120 may be formed of a metal, ABS, or other suitable material. Each side branch 120 may overlap with a portion of main body 125 and may include a number of circular apertures 124 capable of accepting fasteners “F”. Most fasteners “F” are depicted as screws with a hexagonal socket although it will be understood that other screws, clips or coupling means are capable of being used instead of some or all of the screws.

A fabric 140 may be disposed above and coupled to main body 125. The fabric 140 may be formed of a woven nylon fabric (or nylon webbing) or other suitable material. In some examples, the nylon material is reusable as it allows for mechanical adherence of an epoxy or other material, but does not allow impregnation of the adhesive material in the nylon material. The material of fabric 140 may be selected to be durable and to have a surface capable of being securely coupled to the hoof of an animal using an epoxy or other suitable adhesives. Fabric 140 may have two complementary halves, symmetric about a longitudinal axis or may be formed of a unitary layer. Each half, or side of a fabric 140, may include a pair of flaps 141a,141b.

Turning to the top view of FIG. 2, four anchoring members 145 may be attached to main body 125, and may project out of the main body toward the top of the device (i.e., toward the hoof of the animal) to increase rigidity of the device and stabilize it around the hoof when attached. As best shown in FIG. 2, each anchoring member 145 may include a tab 146 and a wire 147 that projects perpendicular to the main body. It will be understood that more or less anchoring members 145 may be used as appropriate.

A multi-layer cushioning base 150 is also shown, the multi-layer base 150 having a shape similar to, or matching that of, main body 125, and being coupled to the main body. Base 150 may include a lower layer 151 made of a ABS, a foam or a copolymer, an intermediate layer 152 made of foam or urethane material, and an upper layer 153 made of foam or urethane material. The three layers 151,152,153 may be coupled together via glue, fasteners or other suitable techniques. In some examples, the materials for base 150 may be chosen so that the stiffness of the materials decreases from the lower layer to the intermediate layer, and from the intermediate layer to the upper layer. As shown, upper layer 153 may include a plurality of apertures 154 formed of divots, openings, ridges or other depressions along its surface. Apertures 154 may extend from one side of upper layer 153 to the other (i.e., may form a passageway through all of the upper layer) or may extend only partially through the upper layer 153. A covering 160 may be applied to upper layer 153. In at least some examples, covering 160 includes a putty or an impression material, such as those used for dental impressions. Covering 160 may also be silicone-based material or vinyl polysiloxane (VPS) or other suitable materials. Covering 160 may be disposed on part of, or the entirety of, the surface of upper layer 153, and may flow into apertures 154. In at least some examples, covering 160 may contact upper layer 153 and portions of intermediate layer 152.

FIG. 3 illustrates a side view of the horseshoe 100 being coupled to the hoof of an affected horse requiring support. As shown, wedge 130 raises the heel of the animal by a predetermined amount, while the side branches provide support near the toe. Fabric 140 has been adhered to the hoof of the animal via epoxy or other suitable means to secure the horseshoe 100 to the hoof. Due to the adjustability of the various components, proper fitment may be achieved by translating the wedge, and/or rotating or translating the side branches. Additionally, if it is necessary to provide additional or less support for the heel, the horseshoe can be easily removed, and the wedge can be interchanged for another wedge having a different incline. Multiple wedges may also be used in succession on the same animal as the animal's gait is observed. Certain adjustments may also be made without entirely removing the horseshoe from the hoof, and specifically without removing the fabric. For example, the wedge may be easily adjusted or replaced by actuating the fasteners without removal of the fabric from the animal. The multi-layer base 150 is also shown, which provides support for the hoof. In this example, the base 150 includes three layers and a covering 160, and the stiffness of each layer is equal to or greater than a previous layer in the direction of arrow S (e.g., the lowermost layer 151 has a stiffness that is equal to or greater than intermediate layer 152, and the intermediate layer 152 has a stiffness that is equal to or greater than upper layer 153).

In another embodiments, shown in FIGS. 4A-C, horseshoe 300 includes a few modifications. FIG. 4A shoes a bottom view of the horseshoe 300, which includes branches 320 that widen at their base, and a notch-shaped wedge 330 disposed between the two branches. Wedge 330 may be generally triangular, or resemble the shape of a guitar pick. Wedge 330 may be formed of a rubber, ABS or other suitable material. Branches 320 and wedge 330 may be coupled to a main body 325 made of ABS or a copolymer.

As shown in FIG. 4B, in some embodiments, a single-layered or multi-layer cushioning base 350 may be used, the base 350 having a shape similar to, or matching that of, main body 325, and being coupled to the main body. Base 350 may be formed of any of the materials previously discussed with reference to the cushioning base of the other examples, and may include a plurality of apertures 354 formed of divots, openings, ridges or other depressions along its surface. Apertures 354 may extend from one side to the other (i.e., may form a passageway through all of the upper layer) or may extend only partially through the layer. A pair of supporting members 351 may be disposed on opposite sides of base 350, the supporting members being formed of ABS, a copolymer, neoprene, urethane, foam or other suitable material.

Cushioning base 350 may be sandwiched between main body 325 and a pair of wings 375 formed of the same material as the notch-shaped wedge 330. FIG. 4C shows a top view of the horseshoe 300, which will be in contact with the hoof of the animal. As shown, wings 375 may further include four anchoring members 345 disposed on corners of the device. When fully assembled, the wings and the notch-shaped wedge may form a generally continuous surface.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

It will be appreciated that the various dependent claims and the features set forth therein can be combined in different ways than presented in the initial claims. It will also be appreciated that the features described in connection with individual embodiments may be shared with others of the described embodiments.

What is claimed is:

1. A horseshoe having a front end and a back end comprising:
a main body;
a pair of side branches coupled to opposing ends of the main body;
a heel wedge coupled to the main body; and
a cushioning base coupled to the main body.

2. The horseshoe of claim 1, further comprising a fabric coupled to at least one of the main body and the pair of side branches.

3. The horseshoe of claim 1, wherein the cushioning base includes two layers.

4. The horseshoe of claim 1, wherein the cushioning base includes a lower layer, an intermediate layer, and an upper layer.

5. The horseshoe of claim 1, wherein the cushioning base includes at least one foam layer.

6. The horseshoe of claim 5, wherein the at least one foam layer includes apertures.

7. The horseshoe of claim 1, wherein the cushioning base includes a urethane material.

8. The horseshoe of claim 5, further comprising a covering disposed on the upper layer.

9. The horseshoe of claim 8, wherein the covering is an impression putty.

10. The horseshoe of claim 9, wherein the impression putty includes vinyl polysiloxane.

11. The horseshoe of claim 1, wherein each of the pair of side branches is coupled to the main body via a fastener, and is capable of articulating about the fastener.

12. The horseshoe of claim 2, further comprising an epoxy disposed on the fabric configured to couple flaps of the fabric to an animal's hoof.

13. A horseshoe having a front end and a back end comprising:
a main body;
a pair of side branches coupled to opposing ends of the main body;
a heel wedge coupled to the main body; and
a multi-layer cushioning base coupled to the main body, the multi-layer cushioning base including at least two layers of different stiffnesses.

14. The horseshoe of claim 13, further comprising a fabric coupled to at least one of the main body and the pair of side branches.

15. The horseshoe of claim 13, wherein the multi-layer cushioning base includes a lower layer, an intermediate layer, and an upper layer.

16. The horseshoe of claim 13, wherein the multi-layer cushioning base includes at least one foam layer.

17. The horseshoe of claim 16, wherein the at least one foam layer includes apertures.

18. The horseshoe of claim 15, further comprising a covering disposed on the upper layer.

19. The horseshoe of claim 18, wherein the covering is an impression putty.

20. The horseshoe of claim 19, wherein the impression putty includes vinyl polysiloxane.
